(19) United States
(12) Patent Application Publication
(10) Pub. No.: US 2007/0091117 A1
(43) Pub. Date: Apr. 26, 2007

(54) Electrophoretic display device and a method and apparatus for improving image quality in an electrophoretic display device

(75) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,303

(22) PCT Filed: Nov. 11, 2004
(86) PCT No.: PCT/IB04/52392

§ 371 Date: May 16, 2006

(30) Foreign Application Priority Data
Nov. 21, 2003 (EP) 03104295.5

(51) Int. Cl. G09G 5/00

(52) U.S. Cl. 345/619

(57) ABSTRACT

A method of driving an electrophoretic display device, in which at least one voltage pulse is provided in the drive waveform, prior to the drive signal for effecting a desired image transition according to an image to be displayed. The voltage pulse has a polarity and energy which is dependent on, and determined by, a current optical state, irrespective of the next optical state to be acquired by a picture element, and causes the charged particles of an electrophoretic medium to be moved in a direction away from the nearest electrode thereto.

This invention relates to an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, and drive means arranged to supply a sequence of drive signals to said electrodes, each drive signal causing said particles to occupy a predetermined optical state corresponding to image information to be displayed.

An electrophoretic display comprises an electrophoretic medium consisting of charged particles in a fluid, a plurality of picture elements (pixels) arranged in a matrix, first and second electrodes associated with each pixel, and a voltage driver for applying a potential difference to the electrodes of each pixel to cause the charged particles to occupy a position between the electrodes, depending on the value and duration of the applied potential difference, so as to display a picture.

In more detail, an electrophoretic display device is a matrix display with a matrix of pixels which are associated with intersections of crossing data electrodes and select electrodes. A grey level, or level of colorization of a pixel, depends on the time a drive voltage of a particular level is present across the pixel. Dependent on the polarity of the drive voltage, the optical state of the pixel changes from its present optical state continuously towards one of the two limit situations (i.e. extreme optical states), e.g. one type of charged particles is near the top or near the bottom of the pixel. Intermediate optical states, e.g. greyscales in a black and white display, are obtained by controlling the time the voltage is present across the pixel.

Usually, all of the pixels are selected line-by-line by supplying appropriate voltages to the select electrodes. The data is supplied in parallel via the data electrodes to the pixels associated with the selected line. If the display is an active matrix display, the select electrodes are provided with, for example, TFT's, MIM,s, diodes, etc., which in turn allow data to be supplied to the pixel. The time required to select all of the pixels of the matrix display once is called the sub-frame period. In known arrangements, a particular pixel either receives a positive drive voltage, a negative drive voltage, or a zero drive voltage during the whole sub-frame period, depending on the change in optical state, i.e. the image transition, required to be effected. In this case, a zero drive voltage is usually applied to a pixel if no image transition (i.e. no change in optical state) is required to be effected.

A known electrophoretic display device is described in international patent application WO 99/53373. This patent application discloses an electronic ink display comprising two substrates, one of which is transparent, and the other is provided with electrodes arranged in rows and columns. A crossing between a row and a column electrode is associated with a picture element. The picture element is coupled to the column electrode via a thin-film transistor (TFT), the gate of which is coupled to the row electrode. This arrangement of picture elements, TFT transistors and row and column electrodes together forms an active matrix. Furthermore, the picture element comprises a pixel electrode. A row driver selects a row of picture elements and the column driver supplies a data signal to the selected row of picture elements via the column electrodes and the TFT transistors. The data signal corresponds to the image to be displayed.

Furthermore, an electronic ink is provided between the pixel electrode and a common electrode provided on the transparent substrate. The electronic ink comprises multiple microcapsules of about 10 to 50 microns. Each microcapsule comprises positively charged white particles and negatively charged black particles suspended in a fluid; When a positive field is applied to the pixel electrode, the white particles move to the side of the microcapsule on which the transparent substrate is provided, such that they become visible/white to a viewer. Simultaneously, the black particles move to the opposite side of the microcapsule, such that they are hidden from the viewer. Similarly, by applying a negative field to the pixel electrode, the black particles move to the side of the microcapsule on which the transparent substrate is provided, such that they become visible/black to a viewer. Simultaneously, the white particles move to the opposite side of the microcapsule, such that they are hidden from the viewer. When the electric field is removed, the display device substantially remains in the acquired optical state, and exhibits a bi-stable character.

Grey scales (i.e. intermediate optical states) can be created in the display device by controlling the amount of particles that move to the counter electrode at the top of the microcapsules. For example, the energy of the positive or negative electric field, defined as the product of field strength and the time of application, controls the amount of particles moving to the top of the microcapsules.

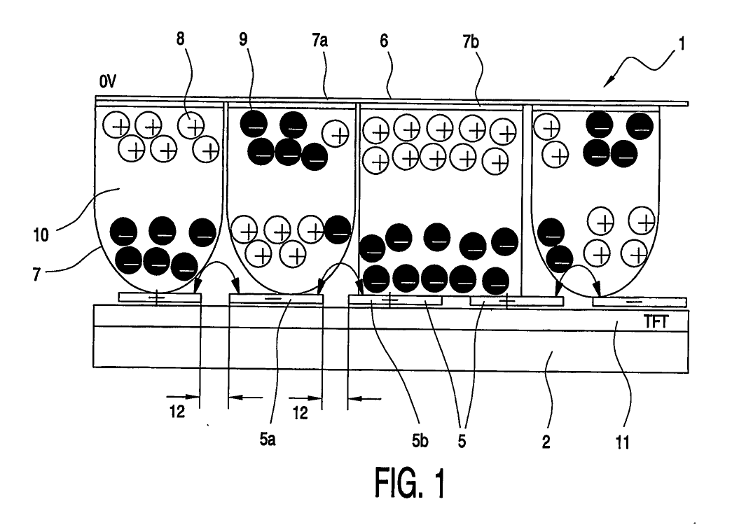

FIG. 1 of the drawings is a diagrammatic cross-section of a portion of an electrophoretic display device 1, for example, of the size of a few picture elements, comprising a base substrate 2, an electrophoretic film with an electronic ink which is present between a top transparent electrode 6 and multiple picture electrodes 5 coupled to the base substrate 2 via a TFT 11. The electronic ink comprises multiple microcapsules 7 of about 10 to 50 microns. Each microcapsule 7 comprises positively charged white particles 8 and negatively charged black particles 9 suspended in a fluid 10. When a positive field is applied to a picture electrode 5, the black particles 9 are drawn towards the electrode 5 and are hidden from the viewer, whereas the white particles 8 remain near the opposite electrode 6 and become visible white to a viewer. Conversely, if a negative field is applied to a picture electrode 5, the white particles are drawn towards the electrode 5 and are hidden from the viewer, whereas the black particles remain near the opposite electrode 6 and become visible black to a viewer. In theory, when the electric field is removed, the particles 8, 9 substantially remain in the acquired state and the display exhibits a bi-stable character and consumes substantially no power.

In order to increase the response speed of an electrophoretic display, it is desirable to increase the voltage difference across the electrophoretic particles. In displays based on electrophoretic particles in films, comprising either capsules (as described above) or micro-cups, additional layers, such as adhesive layers and binder layers are required for the construction. As these layers are also situated between the electrodes, they can cause voltage drops, and hence reduce the voltage, across the particles. Thus, it is possible to increase the conductivity of these layers so as to increase the response speed of the device.

Thus, the conductivity of such adhesive and binder layers should ideally be as high as possible, so as to ensure as low as possible a voltage drop in the layers and maximise the switching or response speed of the device. However, edge image retention/ghosting is often observed in active matrix electrophoretic displays, which becomes more severe as the conductivity of the adhesive layer is increased.

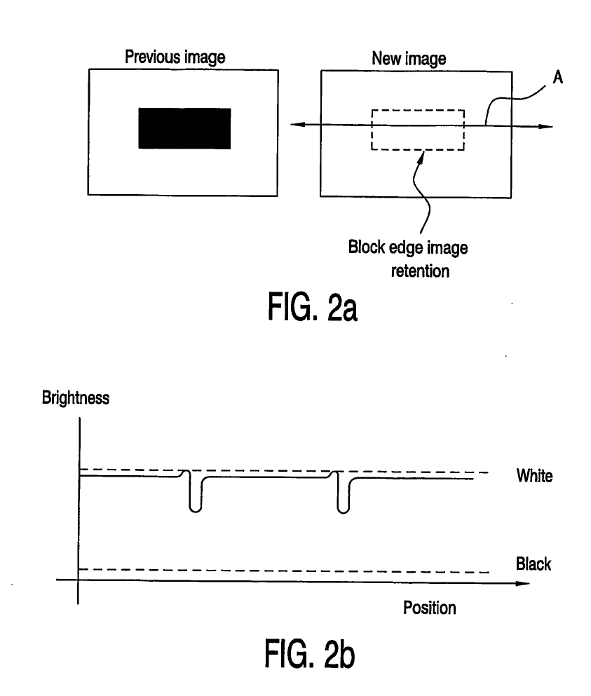

An example of edge ghosting is schematically illustrated in FIG. 2a of the drawings, in which the display is first updated with a simple black block on a white background, and then updated to a full white state. As shown, a dark outline corresponding to the edge of the original black block appears, i.e. at the position where the transition from black to white areas was previously present. A clear brightness drop is seen at or around these lines, as illustrated in FIG. 2b. This is because these areas have not received sufficient energy during an image update period, due to lateral crosstalk.

The term crosstalk refers to a phenomenon whereby the drive signal is not only applied to a selected pixel but also to other pixels around it, such that the display contrast is noticeably deteriorated. The manner in which this can occur is illustrated in FIG. 1. For example, consider the case where voltages of opposing polarity are applied to adjacent pixel electrodes 5, in the event that opposing optical states are intended to be effected in respective adjacent microcapsules, such as in the case of pixel electrodes 5a and 5 b, and respective microcapsules 7a and 7b. In the case of electrode 5a, a negative field is applied in order to draw the white charged particles 8 towards the electrode 5a and cause the black charged particles 9 to move toward the opposite electrode 6, and a positive field is applied to the electrode 5b in order to draw the black charged particles 9 towards the electrode 5b and cause the white charged particles 8 to move toward the opposite electrode 6. However, because the space 12 between the electrodes 5a and 5b is relatively small (by necessity, otherwise the resolution of the resultant image would be adversely affected), the field applied to the electrodes 5a and 5b may have an effect on the charged particles in the adjacent microcapsules 7b and 7a. As shown, therefore, even though a negative field is applied to the electrode 5a, it is partially cancelled by the positive field applied to electrode 5b, with the effect that a few black charged particles 9 close to the side of the microcapsule 7a nearest the adjacent pixel electrode 5b may not be supplied with sufficient energy for them to be pushed toward the electrode 6, and a few white charged particles may not be supplied with sufficient energy to be drawn toward the electrode 5a.

The adverse effect of lateral crosstalk when it comes to the edge image retention illustrated in FIG. 2a, is particularly noticeable, and becomes worse, when a picture element is switched to black and the neighbouring pixels need to go to white. This is particularly visually disturbing because it is more visible than normal area image retention (i.e. in the case where an entire block is a little brighter or darker), and this is particularly unacceptable when the supposedly white area is required to remain at its nominal white state such that the respective pixels are not updated because of the bi-stable characteristic of the electrophoretic display.

Because of the bi-stable characteristics, the pixels without optical state change are usually not updated. However, the image stability is always relative and in practice the brightness will drift away from the initial value with an increased image holding time. A simple integration of such “ghosting” during next image updates is also unacceptable, in the sense that if the pixels were simply to be updated from white to white using a simple “top-up”, i.e a single voltage pulse of the appropriate polarity, the above-mentioned problem may be worsened and the greyscale accuracy is likely to be significantly reduced during subsequent transitions because the charged particles may stick to each other/or to the electrode by multiple times update using a single polarity voltage pulse, making it difficult to move them away when effecting the next desired image transition.

It is an object of the present invention to reduce, if not eliminate, such edge image retention and ghosting, and we have now devised an arrangement which overcomes the problems mentioned above.

Thus, in accordance with the present invention, there is provided an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, and drive means arranged to supply a drive waveform to said electrodes, said drive waveform comprising: a) a sequence of drive signals, each effecting an image transition by causing said particles to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles to be moved in a direction away from the electrode nearest thereto.

The present invention also extends to a method of driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the method comprising supplying a drive waveform to said electrodes, said drive waveform comprising: a) a sequence of drive signals, each effecting an image transition by causing said particles to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles to be moved in a direction away from the electrode nearest thereto.

The present invention extends further to apparatus for driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the apparatus comprising drive means arranged to supply a drive waveform to said electrodes, said drive waveform comprising: a) a sequence of drive signals, each effecting an image transition by causing said particles to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles to be moved in a direction away from the electrode nearest thereto.

The invention extends still further to a drive waveform for driving an electrophoretic display device comprising an electrophoretic material comprising charged particles in a fluid, a plurality of picture elements, first and second electrodes associated with each picture element, the charged particles being able to occupy a position being one of a plurality of positions between said electrodes, said positions corresponding to respective optical states of said display device, the apparatus comprising drive means arranged to supply said drive signal to said electrodes, said drive waveform comprising: a) a sequence of drive signals, each effecting an image transition by causing said particles to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles to be moved in a direction away from the electrode nearest thereto.

The present invention offers significant advantages over prior art arrangements, including reduction or elimination of block edge retention and ghosting, and the ability to provide an increased number of intermediate optical states.

The drive waveform may also include a reset pulse, prior to a drive signal. The reset pulse is a voltage pulse capable of bringing particles from the present position to one of the two extreme positions close to the two electrodes. The reset pulse may consist of “standard” reset pulse and “over-reset” pulse. The “standard” reset pulse has a duration proportional to the distance that particles need to move. The duration of an “over-reset” pulse is selected according to the independent image transitions to ensure greyscale accuracy and satisfy DC-balancing requirements. One or more shaking pulses may be provided in the drive waveform. In one embodiment, one or more shaking pulses may be provided prior to the voltage pulse. An additional one or more shaking pulses may be provided between the at least one voltage pulse and the drive signal. In a preferred embodiment, an even number of shaking pulses, say four, are provided in the drive waveform prior to the voltage pulse and/or between the voltage pulse and the drive signal. The length of the or each shaking pulse is beneficially of an order of magnitude shorter than the minimum time period of a drive signal required to drive the optical state of a picture element from one extreme optical state to the other.

A shaking pulse is defined as a single polarity voltage pulse representing an energy value sufficient to release particles at any one of the positions between the two electrodes, but insufficient to move the particles from a current position to one of the two extreme positions close to one of the two electrodes. In other words, the energy value of the or each shaking pulse is preferably insufficient to significantly change the optical state of a picture element.

The display device may comprise two substrates, at least one of which is substantially transparent, whereby the charged particles are present between the two substrates. The charged particles and the fluid are preferably encapsulated, more preferably in the form of individual microcapsules each defining a respective picture element.

The display device may have at least two, and more preferably, at least three optical states. The drive waveform may be pulse width modulated or voltage modulated, and is preferably dc-balanced.

These and other aspects of the present invention will be apparent from, and elucidated with reference to, the embodiments described herein.

Embodiments of the present invention will now be described by way of examples only and with reference to the accompanying drawings, in which:

FIG. 1 is a schematic cross-sectional view of a portion of an electrophoretic display device;

FIG. 2a is a schematic illustration of block image retention in an electrophoretic display panel;

FIG. 2b is a brightness profile taken along the arrow A in FIG. 2a;

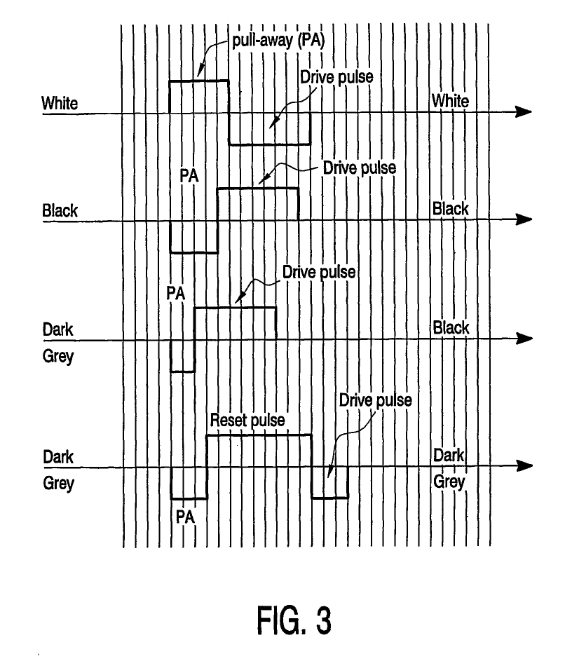

FIG. 3 illustrates representative drive waveforms in respect of a first exemplary embodiment of the present invention; and

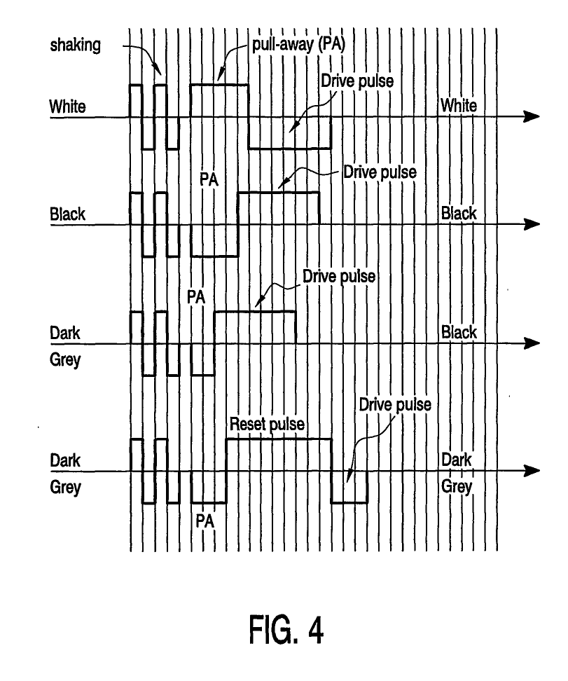

FIG. 4 illustrates representative drive waveforms in respect of a second exemplary embodiment of the present invention.

Thus, the present invention is intended to provide a method and apparatus for driving an electrophoretic display, with the object of at least reducing block image retention, and with the additional benefit of enabling the provision of an increased number of intermediate optical states (e.g. greyscales in a black and white display) relative to prior art arrangements. The invention is realised by the provision in the drive waveform of at least one voltage pulse preceding each drive signal, wherein the polarity and energy represented by each said voltage pulse is dependent on, and determined by a current optical state, and wherein each voltage pulse causes the charged particles to be moved in a direction away from the electrode nearest thereto.

Thus, the voltage sign and energy involved in a “pull away” impulse are determined by the image transition to be effected, and image sticking and/or ghosting has been found to be significantly reduced.

Consider the case of an electrophoretic display device as described above, having two extreme optical states, i.e. white and black, and, say three intermediate optical states wherein the charged particles are in respective intermediate positions between the two electrodes so as to give the picture element respective appearances intermediate the two extreme optical states, e.g. light grey, middle grey and dark grey.

FIG. 3 illustrates representative drive waveforms in respect of a first exemplary embodiment of the present invention, for image transitions white-white, black-black, dark grey-black and dark grey-dark grey. Each drive waveform comprises a “pull away” (PA) voltage pulse in respect of all of the above image transitions. It can be seen that the sign or polarity of the PA pulse depends on the current optical state and is selected such that the charged particles are caused to move away from the nearest electrode. For example, in an arrangement as described above, if the current optical state is white, i.e. the positively charged white particles are near the transparent electrode, then in order to pull the charged particles away from the transparent electrode, it is necessary for the PA pulse to have a positive polarity, regardless of the image transition to be effected.

Thus, referring to FIG. 3, the white-white image transition is illustrated. As explained above, initially, a positive “pull away” pulse is applied in order to cause the positively charged white particles to move away from the transparent electrode. The total energy involved in the PA pulse should be sufficient to move the particles away from the transparent electrode but is preferably insufficient to move the particles across the, or the next, optical state. In order to ensure that the picture element is returned to its white state, a negative driving pulse must subsequently be applied.

Irrespective of the next optical state required to be displayed by a picture element, if the current optical state is black, a negative PA pulse is first applied in order to cause the negatively charged black particles to move away from the transparent electrode. Referring again to FIG. 3 of the drawings, a black-black transition is illustrated. As shown, in order to ensure that the picture element is returned to its black state, a positive driving pulse must subsequently be applied.

When the current optical state of a picture element is dark grey, a negative PA pulse is first applied in order to move the particles towards the middle grey optical state, i.e. away from the nearest electrode. In FIG. 3, the dark grey-black transition is illustrated. As shown, a positive driving pulse must subsequently be applied in order to effect the image transition to the black optical state. In the case of the dark grey-dark grey transition, once again, a negative PA pulse is first applied in order to move the particles towards the middle grey optical state, i.e. away from the nearest electrode. In this example, a positive reset pulse is subsequently applied, so that the picture element is reset to the nearest extreme optical state, i.e. black in this case, after which a negative driving pulse is applied to return the picture element to the dark grey state. The reset pulse may consist of “standard” reset pulse and “over-reset” pulse. The “standard” reset pulse has a duration proportional to the distance that particles need to move. The duration of an “over-reset” pulse is selected according to the independent image transitions to ensure greyscale accuracy and satisfy DC-balancing requirements.

In a second exemplary embodiment of the present invention, a series of so-called shaking pulses may be applied to the electrodes prior to the PA pulse. A shaking pulse is defined as a single polarity voltage pulse representing an energy value sufficient to release particles at any one of the optical state positions, but insufficient to move the particles from a current position to another position between the two electrodes, so as to effectively release or “loosen” the particles from their current position without effecting an image transition between optical states.

FIG. 4 of the drawings illustrates representative drive waveforms for the same image transitions as in FIG. 3, but in this case, four shaking pulses are applied prior to the PA pulse in all of the drive waveforms, which further improves image quality. The time interval between the shaking pulses and the PA pulse may be substantially zero. In some cases, the image quality can be still further improved by applying an additional set of shaking pulses prior to the driving pulse, i.e. between the PA pulse and the driving pulse.

Note that the invention may be implemented in passive matrix as well as active matrix electrophoretic displays. The drive waveform can be pulse width modulated, voltage modulated or combined. In fact, the invention can be implemented in any bi-stable display that does not consume power while the image substantially remains on the display after an image update. Also, the invention is applicable to both single and multiple window displays, where, for example, a typewriter mode exists. This invention is also applicable to color bi-stable displays. Also, the electrode structure is not limited. For example, a top/bottom electrode structure, honeycomb structure or other combined in-plane-switching and vertical switching may be used.

Embodiments of the present invention have been described above by way of example only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of thesemeasures cannot be used to advantage.

1. An electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), and drive means arranged to supply a drive waveform to said electrodes (5, 6), said drive waveform comprising: a) a sequence of drive signals, each effecting an image transition by causing said particles (8, 9) to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles (8, 9) to be moved in a direction away from the electrode (5, 6) nearest thereto.

2. A display device according to claim 1, wherein the drive waveform further includes a reset pulse, prior to one of the drive signals.

3. A display device according to claim 2, wherein a reset pulse, prior to a drive signal, comprises an additional reset duration.

4. A display device according to, wherein the drive waveform further includes one or more shaking pulses.

5. A display device according to claim 4, wherein the drive waveform includes one or more shaking pulses prior to said voltage pulse.

6. A display device according to claim 4, wherein the drive waveform includes one or more shaking pulses between said voltage pulse and a subsequent drive signal.

7. A display device according to claim 3, wherein an even number of shaking pulses are provided in the drive waveform.

8. A display device according to claim 4, wherein the shaking pulse has an opposite polarity to the subsequent data pulse when a single shaking pulse is applied.

9. A display device according to claim 3, wherein the length of the or each shaking pulse is of an order of magnitude shorter than the minimum time period of a drive signal required to drive the optical state of a picture element from one extreme optical state to the other.

10. A display device according to claim 3, wherein the energy value of the or each shaking pulse is insufficient to significantly change the optical state of a picture element.

11. A display device according to claim 3, wherein the time interval between the one or more shaking pulses and said voltage pulse is substantially zero.

12. A display device according to claim 1, wherein image transitions include pixels without substantial optical state change.

13. A display device according to claim 1, comprising two substrates, at least one of which is substantially transparent, whereby the charged particles (8, 9) are present between the two substrates.

14. A display device according to claim 1, wherein the charged particles (8, 9) and the fluid (10) are encapsulated.

15. A display device according to claim 1, wherein the charged particles (8, 9) and the fluid (10) are encapsulated in a plurality of individual microcapsules (7), each defining a respective picture element.

16. A display device according to claim 1, having at least three optical states.

17. A display device according to claim 1, wherein the drive waveform is pulse width modulated.

18. A display device according to claim 1, wherein the drive waveform is voltage modulated.

19. A display device according to any one of claim 1, wherein at least one individual drive waveform is substantially dc-balanced.

20. A display device according to claim 1, wherein at least some of the sub-sets of closed loops wherein an image transition cycle causes a pixel to have substantially the same optical state at the end of said cycle as at the beginning, are substantially dc-balanced.

21. A method of driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), the method comprising supplying a drive waveform to said electrodes (5, 6), said drive waveform comprising: a) a sequence of drive signals, each effecting an image transition by causing said particles (8, 9) to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles (8, 9) to be moved in a direction away from the electrode (5, 6) nearest thereto.

22. Apparatus for driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), the apparatus comprising drive means arranged to supply a drive waveform to said electrodes (5, 6), said drive waveform comprising: a) a sequence of drive signals, each effecting an image transition by causing said particles (8, 9) to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles (8, 9) to be moved in a direction away from the electrode (5, 6) nearest thereto.

23. A drive waveform for driving an electrophoretic display device (1) comprising an electrophoretic material comprising charged particles (8, 9) in a fluid (10), a plurality of picture elements, first and second electrodes (5, 6) associated with each picture element, the charged particles (8, 9) being able to occupy a position being one of a plurality of positions between said electrodes (5, 6), said positions corresponding to respective optical states of said display device (1), the apparatus comprising drive means arranged to supply said drive signal to said electrodes (5, 6), said drive waveform comprising: a) a sequence of drive signals, each effecting an image transition by causing said particles (8, 9) to occupy a predetermined optical state corresponding to image information to be displayed, and b) at least one voltage pulse preceding each drive signal, wherein the polarity and energy represented by each said voltage pulse is dependent on, and determined by a current optical state, and wherein each voltage pulse causes said particles (8, 9) to be moved in a direction away from the electrode (5, 6) nearest thereto.
